(19) United States
(12) Patent Application Publication
(10) Pub. No.: US 2006/0036478 A1
(43) Pub. Date: Feb. 16, 2006

(54) System, method and computer program for interactive voice recognition scheduler, reminder and messenger

(76) Inventors: Vladimir Aleynikov, Richmond Hill (CA); Yuri Begeshev, Richmond Hill (CA)

Correspondence Address: MILLER THOMPSON, LLP, 20 QUEEN STREET WEST, SUITE 2500, TORONTO, ON, M5H 3S1, CA

(21) Appl. No.: 10/916,543

(22) Filed: Aug. 12, 2004

(51) Int. Cl. G05B 19/418

(52) U.S. Cl. 705/8

(57) ABSTRACT

A system, method and computer program for automated appointment scheduling is provided. The system includes a computer linked to a voice messaging utility and to a database and the computer program of the present invention. The computer program defines a scheduling engine that includes a two-way interactive voice response engine, and that enables a user to place a call to the computer and book an appointment by means of a scheduling menu that includes one or more hierarchically defined menu options dynamically defined by the scheduling engine based on user input provided by the user. The computer program enables the scheduling of one or more appointments by users on a fully automated basis. A method of providing automated telephone appointment booking to one or more users is provided, as well as a method for one or more users to book an appointment via an automated telephone appointment booking attendant.

### FIELD OF INVENTION

This invention relates in general to telephony scheduling technologies. This invention also relates to interactive voice response technologies. This invention relates more particularly to telephony scheduling utilities that operate by means of Interactive Voice Response (IVR).

### BACKGROUND OF INVENTION

Interactive voice response systems are known. For example, prior art IVR systems are known that enable information retrieval, self-help, order and payment processing, directory navigation.

There are a number of disadvantages to these prior art solutions. First, most of such systems involve human operator taking over the call at some time. This limits the efficiency of such technology because the number of agents is usually limited, and therefore availability of the system is negatively affected when the agents are utilized to capacity during peak times. The added cost of use of agents is also disadvantageous. Also, these solutions generally either (a) are not suitable for relatively complex communication processes, or (b) they are somewhat difficult or time consuming to configure to implement such relatively complex communication processes.

Two-way IVR solutions are known that are operable to select particular data based on requests made over the phone. This occurs by operation of a sound recognition utility that recognizes the sound request and translates the sound request into an electronic data request. That data request is applied to a database to provide data from the database that best matches the electronic data request. An example of this type of solution is the IVR directory solution used by Bell Canada. This solution prompts a user by telephone to provide their request for a particular telephone listing. The voice request is translated into a database query. The matching telephone listing is provided by voice to the user.

Two-way IVR solutions generally have a number of disadvantages. They often do not include adequate logic to enable relatively complex communication processes. Alternatively, prior art IVR solutions that include logic capable of enabling relatively complex communication processes are generally expensive server based solutions that are not within the means of small to medium size enterprises. Also, these prior art server based solutions is generally complicated to implement.

What is needed therefore is an IVR communication utility that enables scheduling. What is also needed is an IVR scheduler that is relatively easy and inexpensive to implement, and enables relatively complex communication processes.

### SUMMARY OF INVENTION

In accordance with one aspect of the present invention, there is provided a system for automated appointment scheduling comprising: a computer linked to a voice messaging utility and to a database; and a computer application linked to the computer, the computer application defining on the computer: a scheduling engine that includes a two-way interactive voice response engine, and that enables a user to place a call to the computer and book an appointment by means of a scheduling menu that includes one or more hierarchically defined menu options dynamically defined by the scheduling engine based on user input provided by the user.

In accordance with another aspect of the present invention, there is provided a computer program for automated appointment scheduling, for use in association with a computer, the computer being linked to a voice messaging utility and a database, the computer program comprising computer instructions for defining on the computer: a scheduling engine that includes a two-way interactive voice response engine, and that enables a user to place a call to the computer and thereby book an appointment by means of a scheduling menu that includes one or more hierarchically defined menu options dynamically defined by the scheduling engine based on user input provided by the user.

In accordance with yet another aspect of the present invention, there is provided a method of providing automated telephone appointment booking to one or more users comprising the steps of: providing a two-way interactive voice communication system that is operable to receive telephone calls from the one or more users; the one or more users contacting the voice communication system by a dialling a given telephone number; the voice communication system authenticating each of the one or more users by soliciting authentication data from each of the one or more users, and comparing the authentication data provided with the authentication data associated with the user on a database linked to the voice communication system; the voice communication system presenting to the one or more users a scheduling menu that includes a plurality of hierarchical menu options defined by an appointment booking process; and the voice communication system receiving user input from the one or more users, and based on such user input, the voice communication system booking one or more appointments on a fully automated basis.

In accordance with a further aspect of the present invention, there is provided a method for one or more users to book an appointment via an automated telephone appointment booking attendant comprising the steps of: contacting via telephone a two-way interactive voice communication system; providing authentication data to an authentication utility linked to the voice communication system, such authentication utility being operable to compare the authentication data to authentication data for the user stored to a database linked to the voice communication system; and providing user input to one or more scheduling menus defined by a scheduling engine linked to the voice communication system, the scheduling menus defining a plurality of hierarchical menu options corresponding to an appointment booking process, the user thereby booking one or more appointments on a fully automated basis method for one or more users to booking an appointment via an automated telephone appointment booking attendant

### BRIEF DESCRIPTION OF DRAWINGS

A detailed description of the preferred embodiment(s) is (are) provided herein below by way of example only and with reference to the following drawings, in which:

FIG. 1 is a resource diagram illustrating the resources of the communication system of the present invention, in a particular embodiment thereof consisting of a client implementation thereof.

FIG. 2 is a resource diagram illustrating the resources of the communication system of the present invention, in another particular embodiment thereof, consisting of an ASP implementation thereof.

FIG. 3 is a program resource diagram illustrating the principal resources of the computer program of the present invention.

FIG. 4a is a flowchart illustrating the overall method of the present invention, in one embodiment thereof.

FIG. 4b is a flowchart illustrating a further aspect of the method illustrated in FIG. 4a.

FIG. 4c is a flowchart illustrating a further aspect of the method illustrated in FIG. 4a.

FIG. 4d is a flowchart illustrating further aspects of the method illustrated in FIG. 4a.

FIG. 4e is a flowchart illustrating a further aspect of the method illustrated in FIG. 4a.

FIG. 4f is a flowchart illustrating a further aspect of the method illustrated in FIG. 4a.

FIG. 5a is a screenshot that illustrates the graphic user interface of the computer program of the present invention that enables the definition of the various aspects of the scheduling rules, in one aspect thereof.

FIG. 5b is a further screenshot that illustrates the graphic user interface of the computer program of the present invention that enables the definition of the various aspects of the scheduling rules, in one aspect thereof.

FIG. 5c is a still further screenshot that illustrates the graphic user interface of the computer program of the present invention that enables the definition of the various aspects of the scheduling rules, in one aspect thereof.

FIG. 6a is a screenshot that illustrates an aspect of graphic user interface of the calendar provided by the scheduling utility.

FIG. 6b is a further screenshot that illustrates another aspect of graphic user interface of the calendar provided by the scheduling utility.

FIG. 6c is a still further screenshot that illustrates another aspect of graphic user interface of the calendar provided by the scheduling utility.

FIG. 7 illustrates a representative graphic user interface linked to the caller administration utility (50).

In the drawings, preferred embodiments of the invention are illustrated by way of example. It is to be expressly understood that the description and drawings are only for the purpose of illustration and as an aid to understanding, and are not intended as a definition of the limits of the invention.

### DETAILED DESCRIPTION

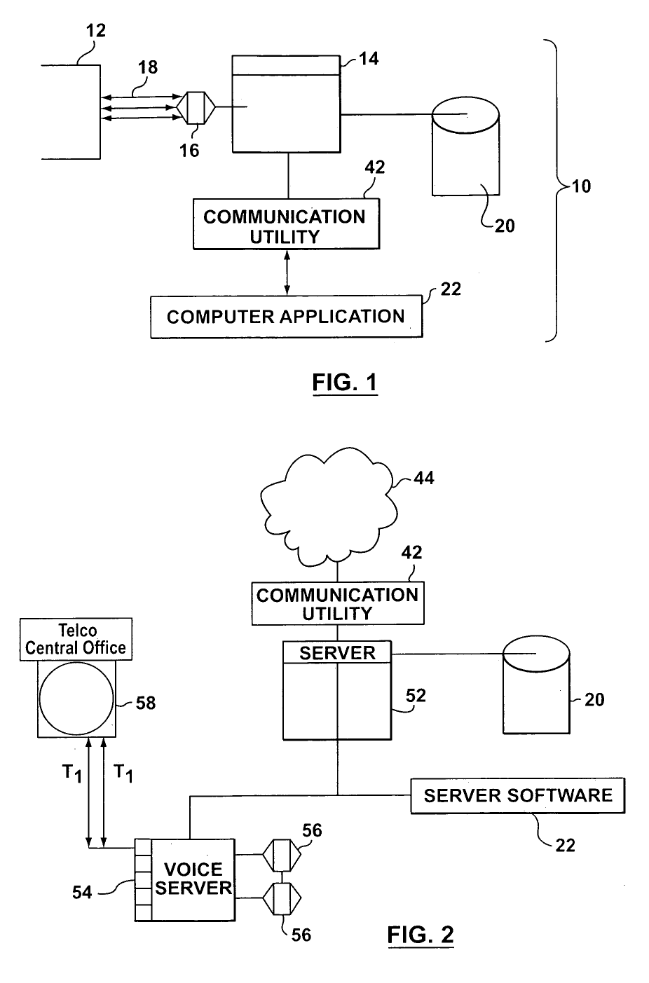

One aspect of the present invention is the communication system (10) illustrated in FIG. 1. The communication system (10) of the present invention is best understood as an IVR system that enables appointment driven businesses to manage service appointments. Appointment driven businesses include medical clinics, dental clinics, hospitals, automobile repair shops, real estate agents, law firms, banks and the like.

The present disclosure relies on the example of a medical clinic. However, it should be understood that this example is used for illustration purposes only. One of the aspects of the present invention is that it can be readily customized to enable any particular communication processes typical in particular appointment driven businesses.

The present invention contemplates at least to implementations of the communication system (10). In one implementation thereof, the communication system (10) of the present invention is integrated with a communication system, such as a telephone system, for example, a Public Switched Telephone Network (PSTN) (12). From this perspective, the communication system (10) is either an aspect of a broader communication system sold to a service provider, or it is integrated with an existing communication system. In either case, this constitutes the client version of the communication system (10), which is best illustrated in FIG. 1.

The present invention also contemplates a client/server implementation, whereby the functions of the present invention are deployed based on an Application Service Provider (ASP) platform. This implementation of the present invention is illustrated in FIG. (2), and further particularized below.

It should be understood that a wide variety of different hardware/software components/architectures/configurations can be used to provide the present invention, in addition to those specifically illustrated in this disclosure. In addition, a wide variety of additional functions, resources or utilities can be linked to the system and/or the computer program of the present invention, without departing from the present invention.

Further details of implementation of the best mode of the system and computer program of the present invention are illustrated in the description of a representative set-up of the system and computer program below.

The communication system (10) is best understood as an electronic telephone attendant. The communication system, in one particular implementation thereof, includes: a computer system such as a standard personal computer (14) with WINDOWS™ operating system installed, and a special telephony card (16) that is operable to:
Connect directly to telephone lines (18);
Offer application controlled call answering (20);
Detect touch tones;
Play voice messages to a caller and digitizes, compresses, and records voice signals, and stores such voice signals (where required) to a database (20) linked to the computer (14); and
Place outbound calls and automatically monitor their progress.

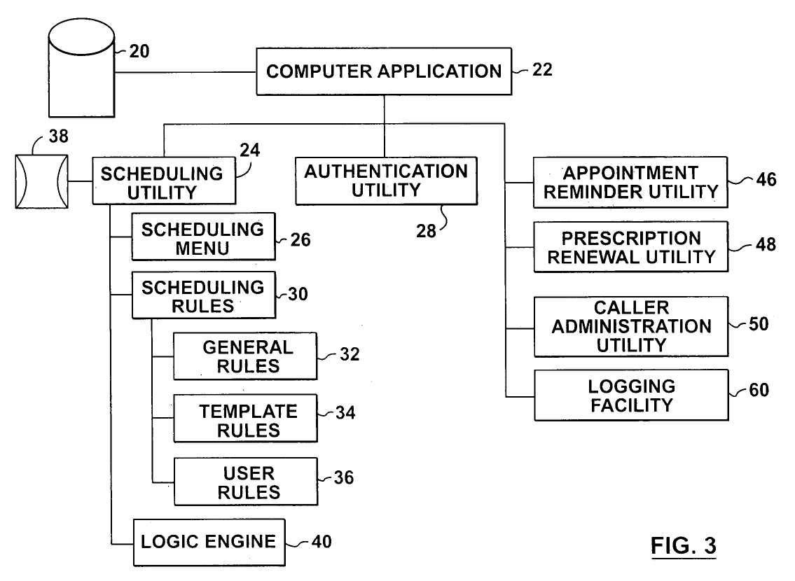

The computer program of the present invention is best understood by reference to FIG. 3. The computer program of the present invention consists of the computer application (22) illustrated in FIG. 2. The computer application (22) includes a scheduling utility (24). The scheduling utility (24) is best understood as an automated IVR scheduling engine.

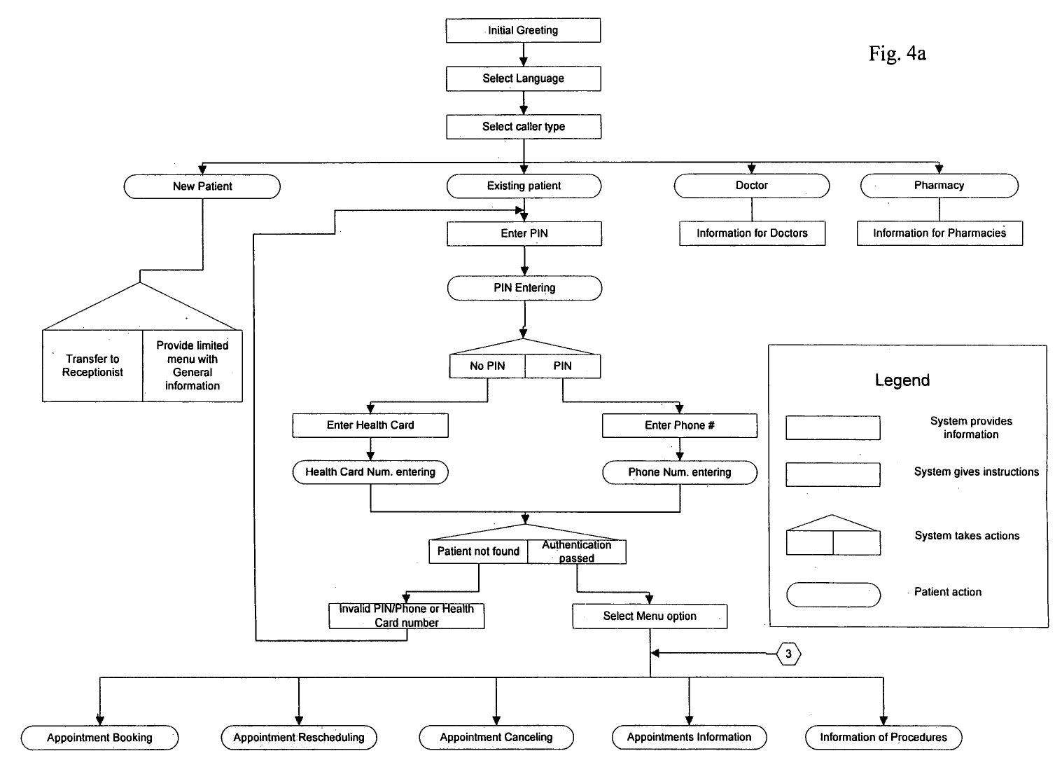

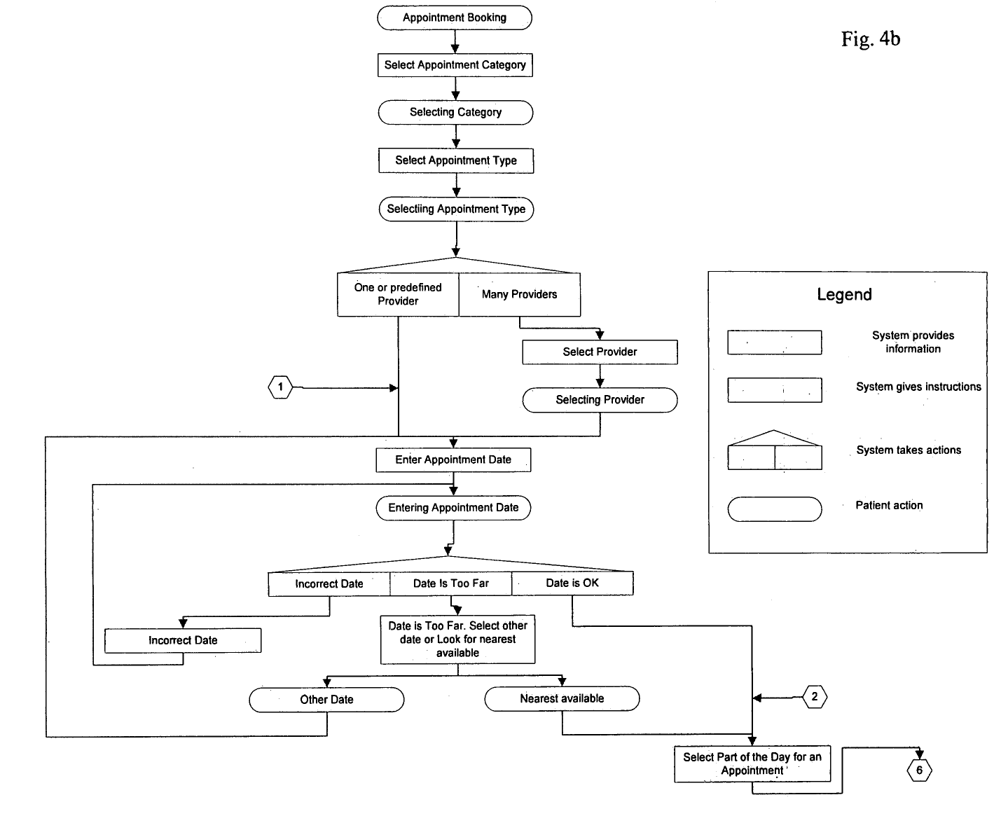

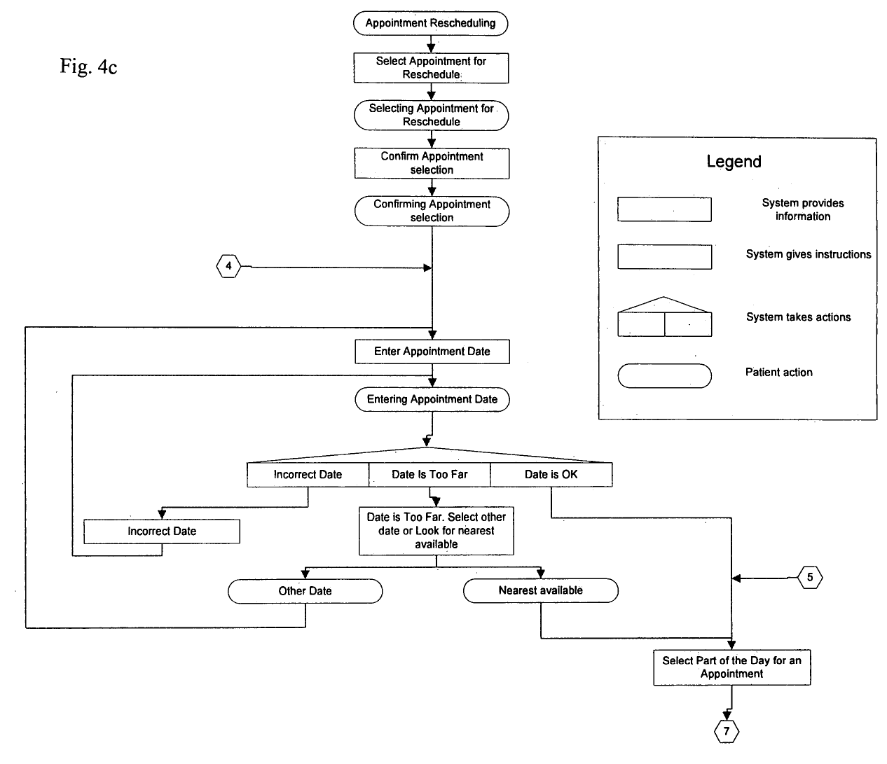

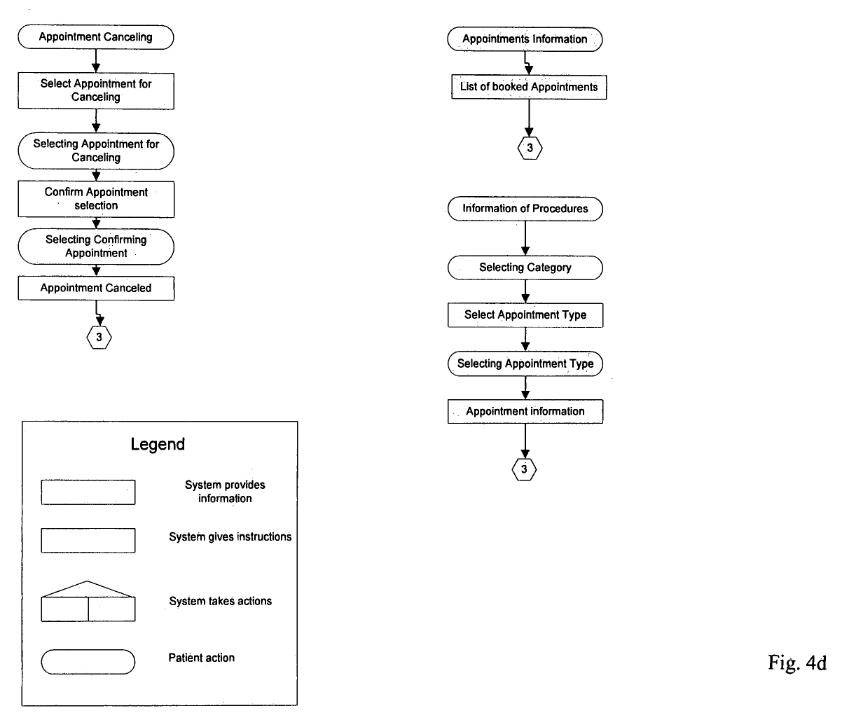

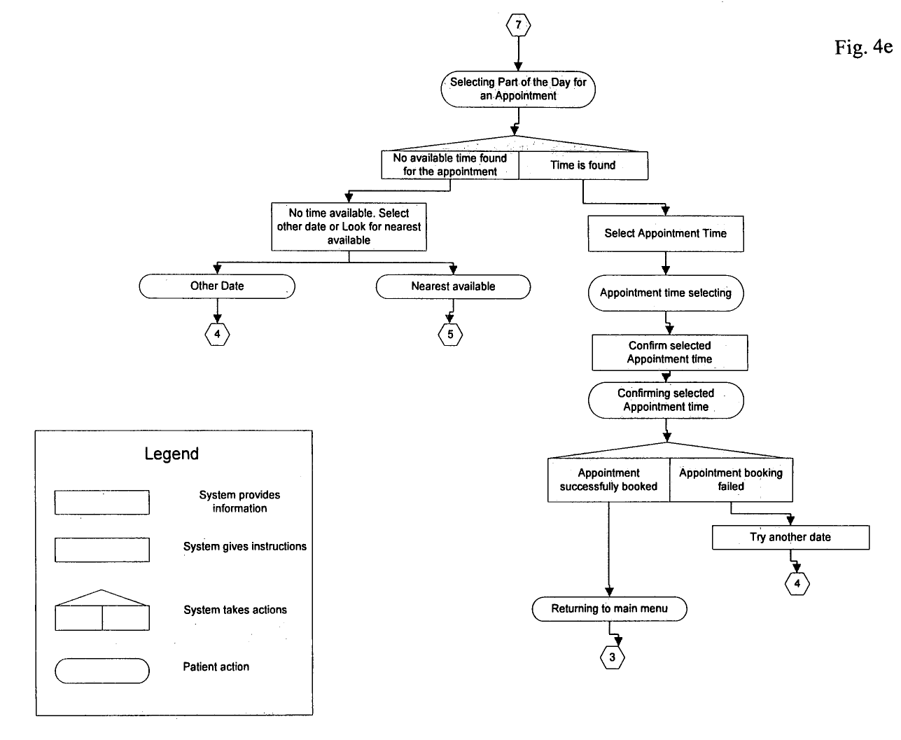

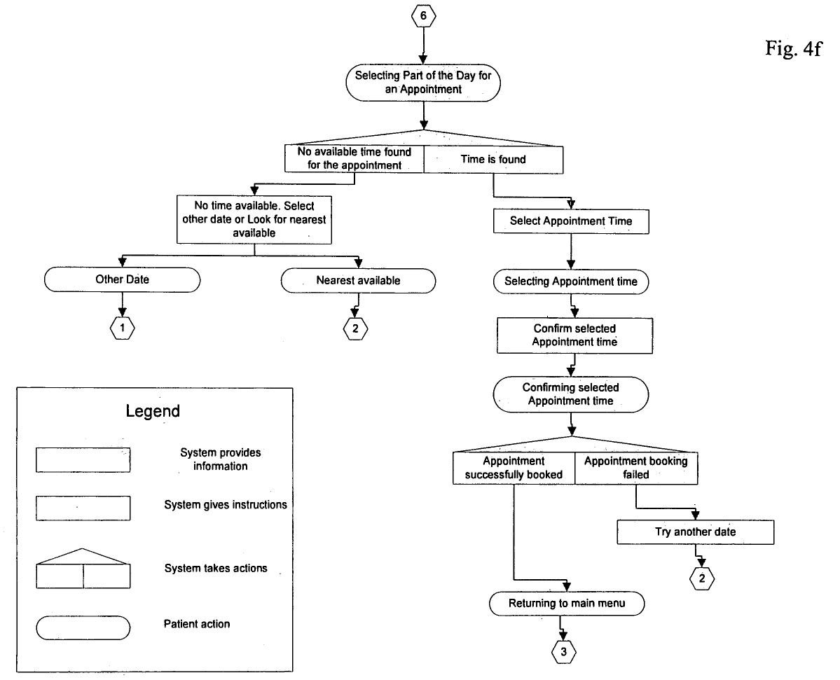

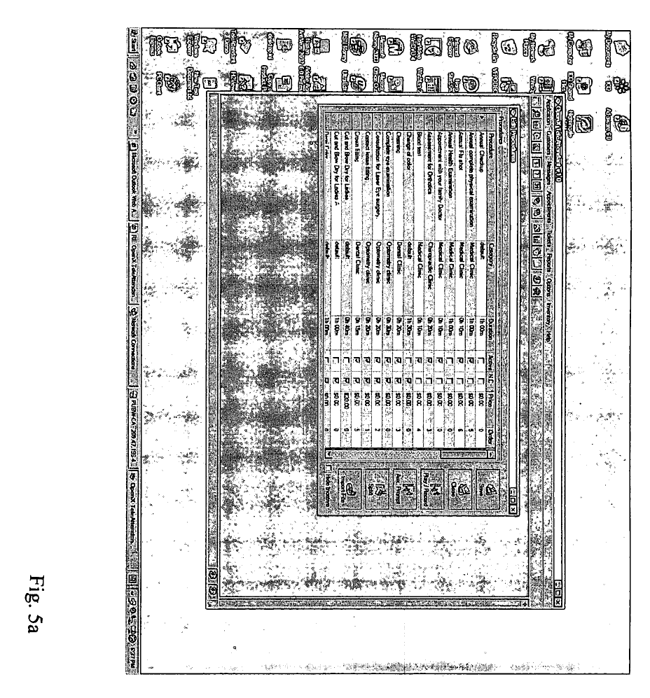

One aspect of the method of the present invention consists of a user booking an appointment. Various aspects of the method of the present invention are illustrated in FIGS. 4a to 4f. FIG. 4a is illustrates a particular aspect of the method of the present invention, namely implementation of the overall method described below in the context of a medical clinic where authentication credentials are provided. FIG. 4b is a flowchart illustrating a further aspect of the method illustrated in FIG. 4a, namely further detailing the method by which an appointment is booked. FIG. 4c is a flowchart illustrating a further aspect of the method illustrated in FIG. 4a, namely the aspect whereby an appointment is rescheduled. FIG. 4d is a flowchart illustrating further aspects of the method illustrated in FIG. 4a, namely aspects whereby an appointment is cancelled, appointment information is accessed, or information on procedures is obtained. FIG. 4e is a flowchart illustrating a further aspect of the method illustrated in FIG. 4a, namely further detail on the booking of an appointment, in accordance with the method of the present invention. FIG. 4f is a flowchart illustrating a further aspect of the method illustrated in FIG. 4a, namely yet another aspect of the booking of an appointment, in accordance with the method of the present invention.

The overall method of booking an appointment by means of an IVR system is best understood as consisting of the following steps:
1. The user contacting the communication system (10) of the present invention by dialling a given telephone number.
2. The user authenticating to the communication system (10) by provide his/her authentication credentials.
3. The communication system (10) of the present invention authenticating the user, thereby providing access to the user to a scheduling menu (26) (illustrated in FIGS. 1 and 3) that includes a plurality of hierarchical options defined by an appointment booking process.
4. The communication system (10) receiving selection input from the user relevant to the appointment booking process, for example, as particularized below.
5. The communication system (10), in response to the selection input, dynamically narrowing the hierarchical options based on the selection input.
6. The user booking his/her appointment by operation of the communication system.

A further aspect of the present invention is that the scheduling menu (26), is provided in more than one language. Accordingly, the method of the present invention in another aspect thereof consists of the further step of the user selecting a language, whereby the communication system (10) thereafter interacts with the user in the selected language.

The authentication described in Steps (2) and (3) above is provided by the authentication utility (28) illustrated in FIG. 2. The authentication utility (28) helps ensure that the communication system (10) is in fact communicating with a known user. The communication system (10) thereby permits its operator to ensure that appointments are booked in a manner that is consistent with the identity of the user. From this perspective, the authentication utility (28) enables a plurality of controls, such as for example only permitting users who are patients of a particular doctor in a clinic associated with the communication system (10) to book an appointment with that doctor.

A further advantage of the authentication utility (28) is that it enables the maintenance of the privacy and security of their data, which is accessible via the computer system (14).

A number of different authentication credentials can be used such as for example, a combination of a publicly available unique identifier or username of the user, as well as a secret password. The publicly available identifier may consist of a telephone number, a driver's license number or Health Card number. This aspect of the invention is illustrated in FIG. 4a.

The authentication utility (28) is best understood as a known login utility that restricts access to the resources of the communication system (10) to only users who have provided a valid username/password combination. This is accomplished by the authentication utility (28) performing a look-up function to the database (20) in a manner that is known, so as to determine whether there is a match between the username/password provided by the user, and the username/password stored for the user to the database (20). One particular aspect of the present invention is that the authentication utility (28) is adapted to permit the user to define its username/password combination in a login routine, provided in a manner that is known.

Another aspect of the authentication utility (28) is that it enables to create different areas within the system associated with different levels of authentication, depending on the sensitivity of the data that is accessible through that area. For example, the system can be configured to enable clients to book appointments with a number of different professionals receiving very different client data. For example, a massage therapist and a medical doctor could be associated with the same system. A phone number could be used to log in to the system for the purposes of booking appointments with the massage therapist, while a stronger level of authentication could be used to book appointments with the medical doctor.

The authentication utility (28) stores to a database (20) linked to the computer (14) the authentication data of the client. It is preferable that the authentication data be stored to the database (20) in a secure manner, for example, by encrypting the data that includes the authentication data to the database (20). Alternatively, access to the database (20) is restricted and the physical access to the database (20) is also secured.

The present invention provides default routine whereby new patients (by operation of this example) who are not known to the communication system (10) are referred to the receptionist and/or provided with general information from the database (20).

The scheduling utility (24) defines a plurality of scheduling rules (30), as illustrated in FIG. 3. In a particular embodiment of the present invention, the scheduling rules (30) consist of rules that are grouped into three different categories. First, are rules of general application (32) or mandatory rules that apply regardless of the particular appointment driven business. Second, are rules of particular application defined by the scheduling utility that reflect particular appointment booking realities of a particular appointment driven business or template rules (34). Third, are scheduling rules that are defined by the operator of the communication system (10) or user rules (36) of the present invention. The scheduling rules (30) are best understood by reference to the description below.

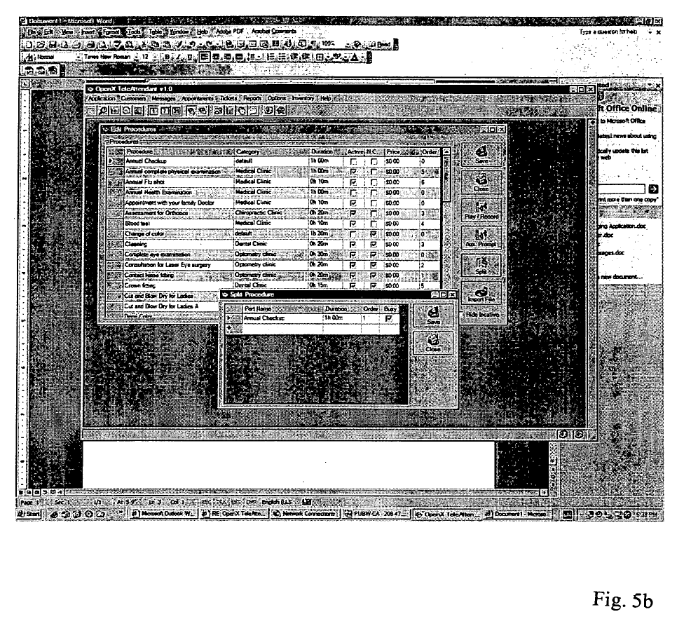

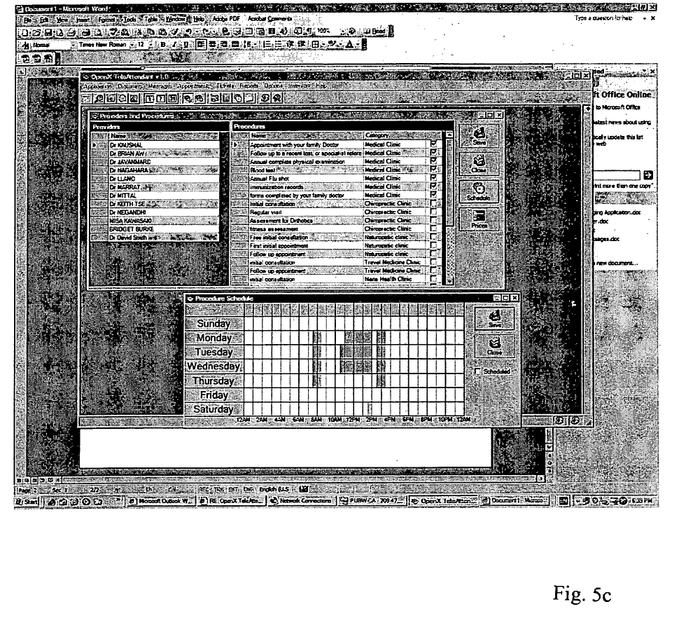

The scheduling utility (30) provides a graphic user interface (38) that enables administrative users to customize the scheduling rules (30). The graphic user interface (38) is provided in a manner that is known. The graphic user interface (38) of the present invention, in one particular implementation thereof, is illustrated in FIGS. 5a to 5c. This graphic user interface (38) is best understood as a scheduling calendar interface similar to the calendar available in OUTLOOK™, with a series of functions accessible through a toolbar that enable the settings associated with a scheduling calendar to be customized by the operator of the system of the present invention.

It should be understood that the scheduling utility (24) in the particular implementation of the present invention enables the provision and/or activation from one or more lists defined by templates of the following items: (1) procedures, as illustrated in FIG. 5a, including the parameters of the provision thereof, such as “CATEGORY”, “DURATION”, “PRICE” and so on; (2) whether specific procedures can be “split” or not, as illustrated in FIG. 5b; and (3) a list of providers, and the relationship between the providers and specific procedures, i.e. which ones they provide, when etc., as illustrated in FIG. 5c.

By way of example, the scheduling rules (30) define, by operation of the scheduling utility one or more of the following scheduling processes:
The time before an available appointment slot when the slot may still be booked. In one particular aspect of the present invention, appoint slots can be booked up to ten minutes before the starting time of the slot. For example, in one particular implementation of the scheduling utility, all appointments in a clinic can be booked up to ten minutes before their start time. It should be understood, that another aspect of the present invention is that the scheduling rules (30) can be set to default to defined setting in relation to a sub-set of the scheduling rules (30). For example, in relation to a client who establishes on the system a history of being late for appointments, the available of options can be restricted, by not permitting the client to exercise the option of booking an appointment within the ten minutes defined by the scheduling rule (30) of ordinary application.
The scheduling utility (24) enables the definition of “appointment types” and defining scheduling rules (30) for different appointment types. The appointment types may correspond to specific procedures, for example, for each of which different scheduling rules (30) may be desirable. This may be because only certain providers in a clinic provide a specific procedure or s/he prefers to perform a particular procedure at a particular time, or the provider only wishes to be booked for a particular procedure a limited number of times per day.
In certain implementations of the present invention, double booking is desirable, based on certain parameters. The parameters may include, for example, the number of clients that can be double booked within a specific time period in relation to a specific appointment type.
On a related point, in certain implementation of the present invention, it may also be desirable to have overlapping bookings in relation to specific appointment types. For example, certain dental procedures can be defined to require an appointment slot that is sub-divided into a plurality of time periods, one or more of which enable overlapping with other appointments. One example is a tooth filling that involves aspects that may not require attention of the health professional during certain phases of the procedure. For example while freezing “takes”.

One aspects of the scheduling utility (24) is that it includes a logic engine (40) that is programmed to apply a series of logical models (not shown) to reduce the number of steps required for a particular client to book an appointment by operation of the scheduling utility (24). The object of the logic engine (24) is to fully automate scheduling process so that no agent is required to complete scheduling transaction. This condition is only achievable due to the comprehensive nature of scheduling rules (30), and the ability of the logic engine (40) to apply these scheduling rules (30) to any given scheduling request The logic engine (40) is operable (in a manner that is well known) to dynamically reduce the number of options available to the client and/or the system in booking an appointment for the client by operation of the scheduling utility (24). Specifically, menus linked to the scheduling utility (24) are being dynamically created on the fly by the logic engine (24). These menus define a series of processing steps that are applied by the scheduling utility (24) and define the interactive appointment booking workflow as between the client and the system of the present invention. This results in significant saving of time and resources, both from the perspective of the client and the service provider.

The operation of the scheduling utility (24), including the logic engine (40), is best understood by operation of an example. (1) A client calls into the system; (2) The client indicates to the system (by selection of a particular menu item) that s/he wishes a particular appointment type; (3) The logic engine (40), based on this input, modifies the running menu to include only providers who have the particular appointment type available. Alternatively, the system recognizes that a particular client has assigned one service provider only, in which case the running menu is significantly reduced to include that one service provider only. The running menu is applied in its current state at any given time to the database (20), for example, to search availability of particular service providers listed on the running menu for appointments requested by the client.

The logic engine (40) also reduces the number of irrelevant options made available to the client. In other words, the main rule of the logic engine (40) is to reduce available choice to the client, thereby improving the efficiency of the system. First, the scheduling utility (24) is operable to only provide options to the client, which are actually available. This reduces the likelihood of the system creating the expectation of a particular appointment time being available when in fact it is not.

Also, by operation of the logic engine (40), in most implementations, the scheduling utility (24) will first ask the client whether s/he prefers to book an appointment (1) on a particular date or (2) on the first available date, in conjunction with a particular time of day. Then, the scheduling utility (24) will in most implementations prompt the client if it has a preference for (4a) morning appointments, (4b) noon appointments, (4c) afternoon appointments or (4d) evening appointments (if available) or (4e) no preference. The menu can be interspersed with options to access tips for booking the most desirable appointment times, for example, “Early morning slots are usually overbooked, late morning slots are underbooked”. This enables the client to learn to use the system and thereby provide the benefit to the client of obtaining an appointment time that meets his/her purposes. This has the further benefit of utilizing the resources of the service provider more efficiently by working with its clients to fill its appointment schedule to capacity.

If the client selects (1) above (i.e. appointment on a particular day), if that day is not available with the particular provider or providers, or the particular appointment type is not available that day for any reason, then the client is offered a further choice: (1a) pick another date or (1b) start with the next available date. When a request for a particular date is received, the system in most implementations also prompts whether the client has any preference as to time of day (morning, noon or evening).

The logic engine (40) is also operable to respect define restrictions and constraints (provided to the scheduling utility (24) during the set-up phase), so as to avoid dynamically conflicts between parameters of provision of service such as conflicts between procedures or events, minimum and maximum times between events and provider recourse or client “unavailability”.

It should be understood that the scheduling utility provides a series of interrelated menu nodes, based on defined logical relationships, provided in a manner that is known. For example, information menu nodes can be established and linked to particular steps in the appointment scheduling process, for example, to receive information on appointment types, and changes to the information. The logic engine (40) is also operable to access from the database (20) and present information relevant to the particular scheduling result achieved by the client. For example, if a client is having a blood test at a particular time of the day, information from the database (20) is accessed regarding special requirements, if any, for having blood tests that particular time of the day. This saves a lot of time to the client and the service provider, and also provides better service to the client.

It should be understood that the scheduling utility is highly configurable, even to the level of particular clients registered to the system. In addition, the scheduling utility is configurable to define and apply sub-sets of the scheduling rules (30) applicable, for example, to members of defined sub-groups of clients registered to the system, usually based on demographic criteria. For example, patients in a medical clinic who are older, or have a particular condition, may require more time than others. The system of the present invention is operable to apply such sub-set of the scheduling rules (30) automatically by matching the identity of the client upon authenticating to the system, and then applying the sub-set of the scheduling rules (30) associated with the particular client on the database (20).

One aspect of the logic engine (40) is that where the client was unable to schedule an appointment due to lack of available timeslots, the logic engine (40) will provide client with an option to include him (her) into a waiting list, defined by operation of the scheduling utility (24). In this case, if another client should cancel his/her appointment, a notification call will be placed to the first client in the waiting list providing an option to schedule this appointment.

Another aspect of the scheduling utility (24) is that it may perform some quick diagnostic tasks in order to provide preliminary information to the service provider in advance, help to select the appropriate appointment type, and in some cases react to emergency situations. For instance, during disease escalations it may be configured to ask certain questions, and if the patient's response is positive, provide necessary instructions, generate alerts, notify appropriate personnel, and redirect this call to a staff member.

It should also be understood that the system and computer program of the present invention is preferably provided with more than adequate resources and availability.

It should be understood that operation of the present invention generates on the database (20) data records associated with particular clients. The database (20) is a known structured database that enables the creation of lists (and other data organizations), including for example call reminder lists (as detailed below).

The system and computer program of the present invention also includes a communication utility (42). The communication utility (42) is a known software tool that enables communications to be made to clients and/or providers linked to the system. These communications include telephone calls, emails, screen pop-ups (in the case of providers), SMS messages and the like. In a particular aspect of the present invention, the communication utility (42) is a known utility connected to the telephony card (16) so as to enable calls to be made by operation of the communication utility (42). Also as illustrated in FIG. 2, the communication utility (42) enables the system of the present invention to connect to the Internet (44). One aspect of the communication utility (42) is a call back feature. The system of the present invention is operable to make calls to lists of clients obtained from the database. One particular aspect of the communication utility (42) of the present invention is that it invokes the authentication utility (28) in relation to clients for whom this features has been turned on. Specifically, in one implementation of this feature, the communication utility (42) of the present invention provides an appointment reminder utility (46) in co-operation with the scheduling utility (24). By operation of the appointment reminder utility (46), a call is made by the system to a particular client simply stating who is calling without stating anything else such as the nature of the appointment, or giving access to any other date. The authentication utility (28) is invoked to obtain the authentication data of the client from the person answering the call. If the authentication data is obtained, then the system knows that the call has been received by the client. At this point the reminder information regarding the appointment is given to the client. In addition, the client can be given access to further information, including for example additional information on the nature of the appointment or procedure. The scheduling utility (24) and the communication utility (42) cooperate to schedule the reminder calls, including further call backs if the client cannot be reached. All this is done automatically by operation of the present invention.

The communication utility (42) is also configurable to escalate a particular scheduled appointment when the reminder call has not been received by the client, for example, within a defined time frame from the scheduled appointment. Escalation may involve notifications to staff members to perform escalatory actions.

Another aspect of the communication utility (42) is that it may broadcast specific voice messages to a list of selected clients based on certain condition. For instance, if used in medical facility, communication utility (42) may broadcast specific voice messages to all patients with certain medical condition. In addition, the same communication utility (42) might be used to broadcast certain voice messages for the purposes of contagious disease control.

One of the added benefits of the appointment reminder utility (46) is that service provider can better address missed appointments or late arrivals as it knows when the client has actually received the reminder, because of the involvement of the authentication utility (28). In prior art systems, the client who has missed a scheduled appointment generally provides the excuse of not having received the reminder. This problem is avoided in the present invention. It is easier to “red flag” the client in the scheduling utility (26) and thereby define parameters for the particular client, for example, further reminders, actually scheduling appointments somewhat later than the time provided to the client.

One aspect of the communication utility (42) is that it logs information to the database (20) regarding times when the client was available, and scheduled calls at those times in the future, while also making further schedule calls at random periods of time within an acceptable range (usually 8:00 am to 9:00 pm) if the reminder call are not received. Another aspect of the communication utility (42) is that if the call is received by somebody other than the client at the client's phone number who may know when it is a better time to call, the system provides an option for this other person to provide this information.

Another aspect of the communication utility (42) is that it enable internal communications within the service provider. One particular aspect of the present invention is that client can call the system of the present invention to obtain a service that requires intervention of one of the personnel of the service provider, which intervention happens by operation of the communication utility (42). One example is a prescription renewal utility (48) provided by the system of the present invention. The prescription renewal utility (48) is provided as an option on the scheduling menu (26) of the system, where applicable. The prescription renewal utility (48) enables the following steps: (1) the client indicates to the communication system (42) that s/he wants to renew a prescription, (2) the communication system (42) accesses from the database the current prescriptions of the client and provides these to the client; (3) the client selects the prescription that the client wishes to renew; (4) the accesses a list of the client's preferred pharmacies and obtains input from the client regarding the particular pharmacy at which the prescription is to be renewed; (5) the communication system (10) communicates to the client that it will receive a communication from the system when the prescription has been renewed. (6) The communication utility (42) sends a message to the client's doctor, for example, as a pop-up screen generated by the communication system (10) on the doctor's computer. (7) When the doctor renews the prescription, the communication system (10) sends a communication to the client. (8) The communication system (10) sends a communication to the pharmacy, such as a fax, email or electronic order via an electronic prescription system.

The prescription renewal utility (48) accesses the prescriptions that the particular client has on file (from the database (20)) and provides them as a series of options from which the client has to select one or more for renewal, by operation of the computer program of the present invention. The computer system (14) then checks to see if that prescription is available for renewal at this time. In a particular implementation of this aspect of the invention, the communication utility (42) then adds the prescription renewal request to a “renewal request list” and in addition (in a particular implementation thereof) invokes a pop up screen on a computerized device of the patient's doctor, which is connected to the computer (14). It should be understood that the computerized device may consist of a personal computer or a personal digital assistant such as a PALM PILOT™ or a BLACKBERRY™. The communication system (10), if the patient's doctor does not approve the prescription within a predetermined waiting time, preferably indicates to the patient that s/he will receive a call back shortly. If the doctor authorizes the renewal, then a call is made to the client, providing a confirmation number for the prescription renewal. The communication system (10) is also operable to contact the pharmacy to provide the particulars of the prescriptions renewal.

Another aspect of the communication utility (42) is that it enables the scheduling of new appointments. A client is scheduled to book a new appointment (e.g. because of recall procedures defined for the client by the scheduling utility (42). The communication utility (42) contacts the client asking the client book an appointment. In this case, the communication utility (42) may leave a message to this effect asking the client to call the system. Or, alternatively, if the client receives the call and logs in by operation of the authentication facility (28), the client is given access to the scheduling utility (42) and thereby books the new appointment.

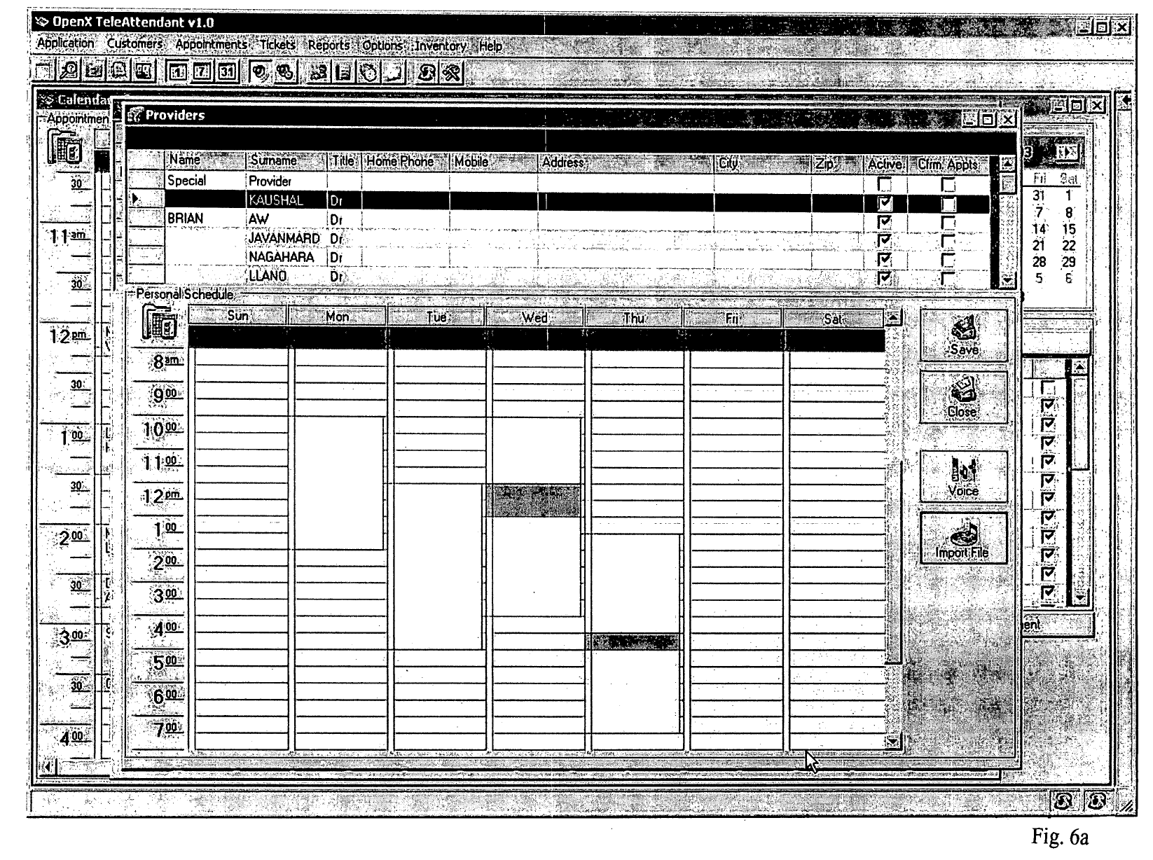

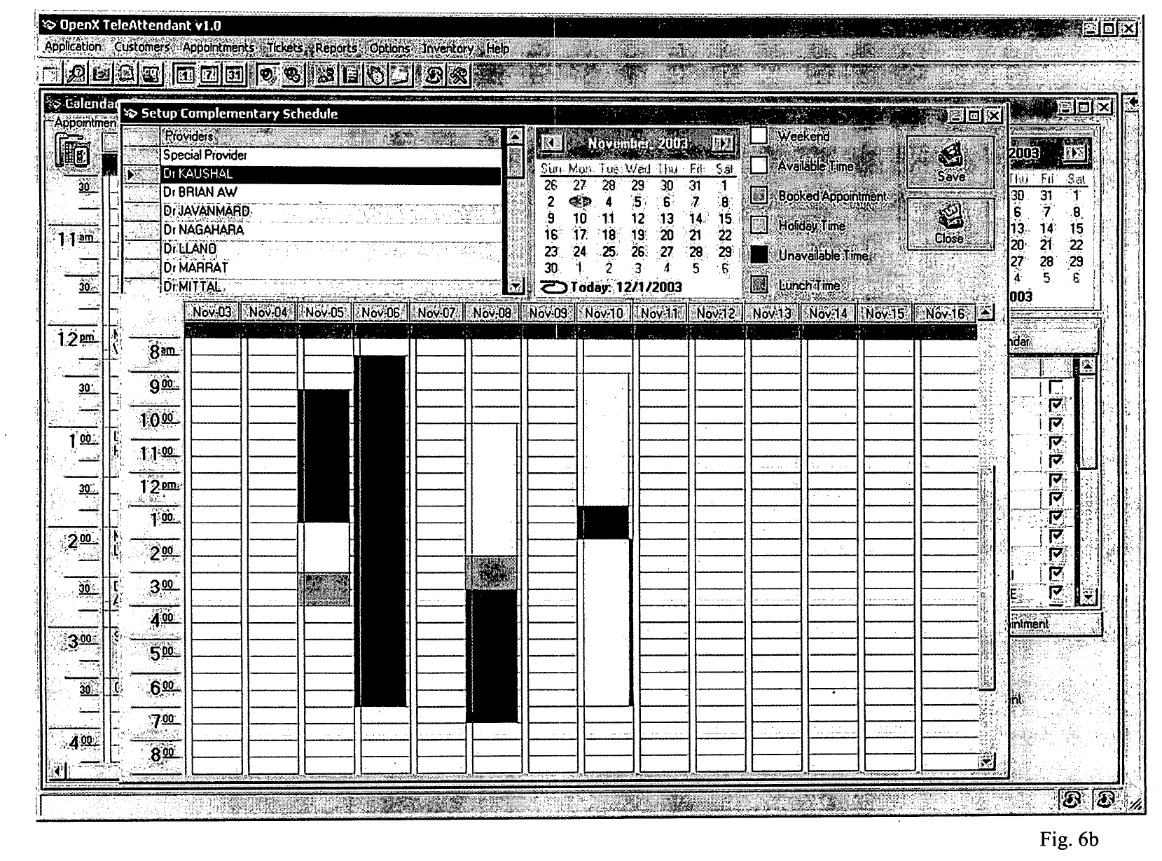

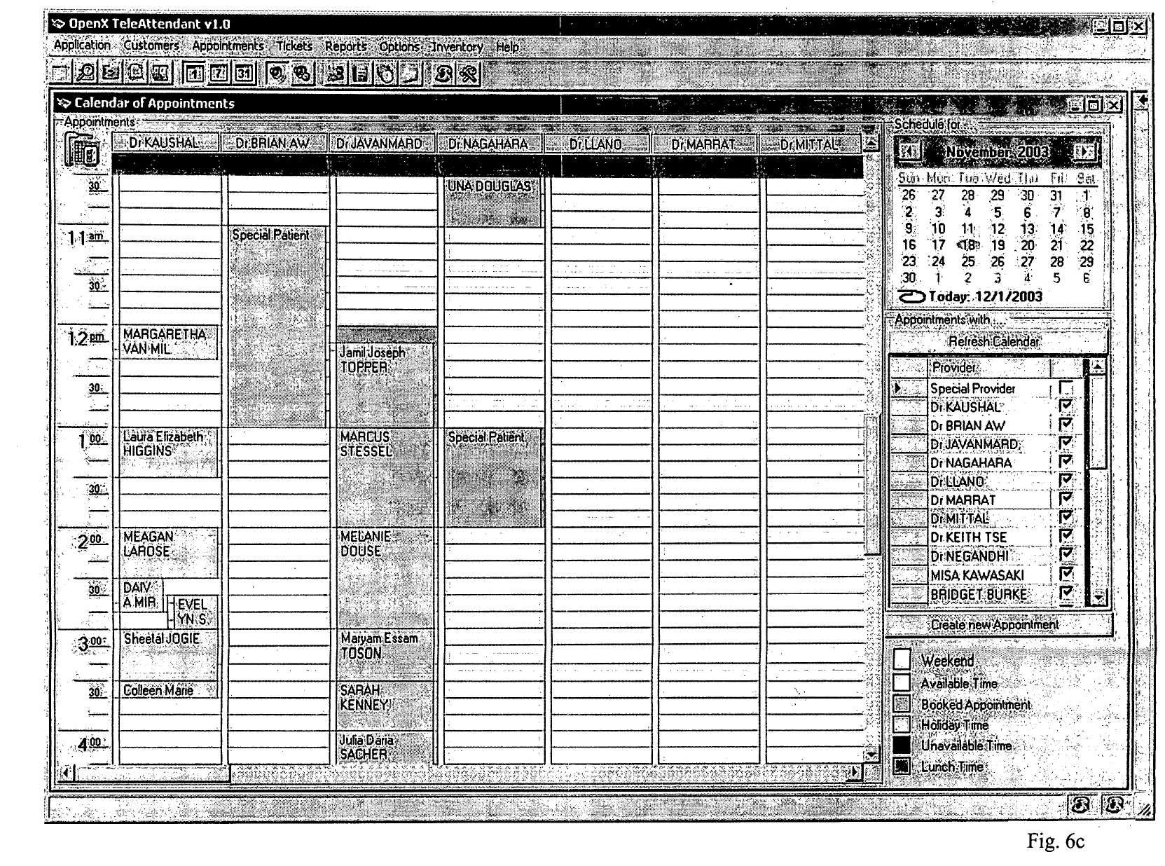

Whenever an appointment is booked by operation of the scheduling utility (24), another aspect of the graphical user interface (38) is that it provides a calendar type software utility that enables the viewing of the various appointments booked, as illustrated in FIGS. 6a, 6b and 6c. FIG. 6a illustrates a view of the calendar showing a list of providers. FIG. 6b illustrates a further view of the calendar that enables the viewing of the appointments scheduled for particular days, in a variety of views, as is known. FIG. 6c illustrates a further view that enables

It should be understood that the scheduling utility (24) is configurable to define various parameters for recalls. For example, rules defining recalls can be applied to all clients, defined sub-groups of clients, or even one particular client based on unique requirements. This functionality is provided by operation of the scheduling rules (30). It should be understood that the present invention enables the configuration of the scheduling rules (30) to define one or more recall procedures enacted by the system of the present invention. For example, in the case of the use of the system of the present invention by an automotive dealership, in the case of a specific recall on a class of vehicles, the system is configurable to contact all individuals who have bought a defined vehicle from the dealership subject to the recall; communicate the relevant information by operation of the communication utility (42), and enable the individuals to book their service appointment by operation of the scheduling utility.

In the client implementation of the communication system (10), in one particular aspect thereof, the communication system (10) is linked to a known PBX system (not shown), and operates in a manner that is known as a feature of the PBX system.

The communication system (10) also includes a caller administration utility (50) (illustrated in FIG. 2) that enables the operator of the client implemented communication system (10) to determine how calls will be handled to the communication system (10). For example, in one of many settings established by operation of known user setting interfaces in a WINDOWS™ environment, the administrative user of the communication system (10) can establish that general calls will go to the receptionist, however, the receptionist can direct individuals calling for an appointment to the communication system (10). Alternatively, the calls can be forwarded from the general number of the service provider to the communication system (10) by default, but the menu defined by the communication system (10) includes an option to contact the receptionist.

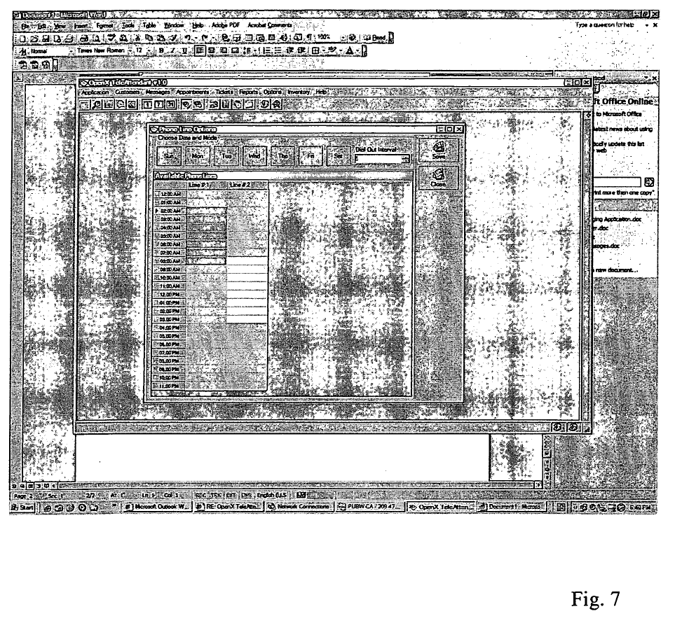

The caller administration utility (50) enables the administrative user to configure the lines available to the communication system (10). For example, the administrative user can define how the available lines will be used within specific time periods during the week. For example, from 9:00 am to 5:00 pm, the lines may be configured for mixed use, i.e. incoming and outgoing lines. During the weekend, for example, the number of lines available for incoming calls may be minimized thereby providing more bandwidth for the computer system (10) to make recall callas, for example. In other words, the caller administration utility (50) enables balance loading of system activities to enable efficient use of available resources. One aspect of a graphic user interface linked to the caller administration utility is illustrated in FIG. 7.

Regarding the client implementation of the present invention, the communication system (10) is usually deployed by loading the computer program of the present invention on a standard personal computer (14), which is configured in a manner that is known to act as a voice server. Computer telephony integration is provided on the personal computer (14). For example, the personal computer (14) is provided with an INTEL™ DIALOGIC™ card or equivalent. The voice cards enable connections between the personal computer (14) and different phone lines (including analog lines, digital lines, or in fact Voice Over IP telephony).

Persistent voice prompts that form part of the various scheduling menus (26) consist of natural voice recordings. Patient names, and some dynamic responses and messages are generated by a Text to Speech (TTS) engine, in a manner that is known.

In accordance with the ASP implementation illustrated in FIG. 2, the service provider generally gives up its main phone number to the server (52). As illustrated in FIG. 2, the server (52) generally includes the following resources, in one illustrative implementation thereof. First, is provided a Voice Server (54) (such as an INTEL™ based server computer) and a number of T1-PRI voice cards (56). The T1-PRI voice cards are connected directly to Telco Central Office (CO) equipment (58) by means of T1 lines. Use of a Digital PRI voice system enables much more sophisticated functions over regular analog phone line. For instance, in this case, a phone number is not assigned to one single phone line anymore. Instead, a single T1-PRI pool may serve virtually any amount of phone numbers. Theoretically, one given service provider may have an access to the full capacity of T1-PRI at a time. T1-PRI allows computer application (22) (which in this case is server software) to communicate with Telco Central Office (58) to send certain commands and retrieve extra information about particular call. For instance, should any given call be redirected to service provider, the server software (22) will command CO to redirect this call eliminating the case when two phone channels will be tied up. In addition, the T1-PRI voice cards (56) provide a failover facility to ensure that all calls gets through.

In this particular implementation, the calls will be end up at the server (52), and only returned to the phone system of the service provider if necessary.

The advantages of the ASP implementation include relatively low set up costs, in comparison to the provision of a dedicated IVR system.

The computer program of the present invention consists of the computer application (22) consisting of the client application illustrated in FIG. 1, or the server application illustrated in FIG. 2. Either way, the computer program (22), in one particular implementation thereof is a WINDOWS™ based computer application. It defines an IVR service (coded, for example in C++) having the functions described in this disclosure, linked to a structured database (20), for example a database provided in SQL™. The IVR service defines a front end defining the client interface, as well as a back end that provides access to the administrative functions described in the present invention. As described above, the IVR service can also define a self-administration module that enables the client, for example, to define or change its administration data.

It should also be understood that in most implementations of the present invention, the scheduling utility (24) of the present invention will be used as central scheduler, which receives IVR appointments, as well as non-IVR appointments. The same scheduler is also preferably used to create work schedules, book time off and the like. Otherwise this data would have to be imported if it impacts on the booking of appointments with clients.

The set up of computer program of the present invention occurs by an administrative user accessing the functions of the scheduling utility to define the various scheduling rules (30) referred to above. In one representative embodiment of the present invention, this involves the following steps: (1) setting up the service providers; (2) defining schedules of the various service providers; (3) defining permissions of service providers (if any) to indicate and update their schedule to the system; (4) define the various appointment types, and parameters thereof. For example, the structure of a particular appointment type and parameters of “squeezing” in relation to components of the structure are defined. This is achieved by simply defining whether during particular components the provider is “busy” or not; (5) define which providers provide which specific appointment types; and (6) engage the calendar provided by the scheduling utility (24) to define the times when the particular provider provides particular appointment types.

It should also be understood that the present invention can be used to reschedule appointments.

Another aspect of the present invention is that it includes a logging facility (60). Every phone call is received by the communication system (10) is logged to the database (20). This is accomplished by tracking the caller identification of the caller, in most telephone networks. The time of the call, and information regarding the reason for the call (provided by selection of one or more items from the menu defined by the system) are also stored to the database (20). The log also preferably reflects the result of the call. Before terminating a call, the communication system (10) preferably confirms to the client the result of the call, and asks for confirmation. In one particular embodiment of the present invention, the communication system (10) asks for the authentication data of the client. This provides additional acknowledgment that it is the client who made the logged selection.

It should be understood that the communication system (10) can also be used to organize and conduct some aspects of clinical trials.

Another particular aspect of the present invention, is that the communication system (10) conducts pre-screening on new patients prior to booking an appointment. This is by storing a phone questionnaire to the database (20), and upon identifying a new patients presents the questionnaire to the new client. Other options include an option in the menu that enables the client to indicate if there is an emergency. In this case, it may be preferable to route calls depending on answer to a few simple but important questions.

It should be understood that performance of the system is important. The creation and application of menus on the fly necessitates significant processing speed, otherwise clients will find use of the communication system (20) to be cumbersome. The system and the computer program are therefore designed to provide maximum speed. This is achieved in a manner that is known to those skilled in the art. The aspect of the overall design that may not be readily obvious to those skilled in the art is how to hand the time slots defined by the scheduling utility (24). It has been found that use of a binary map is a suitable method, whereby binary elements are defined for time slot (from/to) upon entry of data to a particular time slot. It will be obvious to those skilled in the art that this method enables rapid processing of queries to existing time slot entries. One reason for the advantage of this technique is that empty time slots are not searched by necessity when entries are being ought

The present invention also contemplates arrangements that enable savings in long distance charges. In the ASP implementation of the present invention, the voice server (54) can be installed in the same area code as the service provider. This way voice is travelling locally on a telephone network. Data, however, can be stored anywhere, including on a central server (not shown) connected to the Internet. Alternatively, Voice Over IP can solve this problem, but the start-up costs are significant.

It should all be understood that the present invention can linked to various third party systems. For example, in a health care implementation, a billing system can be connected to the communication system (10). Alternatively, a maintenance system can be connected to the communication system (10) in an automotive application of the present invention for the purpose of scheduling service appointments.

What is claimed is:

1. A system for automated appointment scheduling comprising:
(a) A computer linked to a voice messaging utility and to a database; and
(b) A computer application linked- to the computer, the computer application defining on the computer:
(i) A scheduling engine that includes a two-way interactive voice response engine, and that enables a user to place a call to the computer and book an appointment by means of a scheduling menu that includes one or more hierarchically defined menu options dynamically defined by the scheduling engine based on user input provided by the user.

2. The system claimed in claim 1, wherein the computer application further defines on the computer an authentication utility that is operable to enable the computer to:
(a) obtain the input of authentication credentials from the user;
(b) compare the authentication credentials obtained from the user to the authentication credentials for the user stored to the database, and based on such authentication credentials authenticate the user to the computer; and
(c) upon authentication of the user to the computer, provide access to resources and/or data linked to the computer that the user is authorized to access.

3. The system claimed in claim 1, wherein the scheduling engine enables the scheduling of one or more appointments by users on a fully automated basis.

4. The system as claimed in claim 1, wherein the scheduling engine includes a logic engine that is operable to dynamically modify the one or more hierarchically defined menus so as to reduce the number of irrelevant options presented to the user for the purpose of enabling the user to book the appointment.

5. The system as claimed in claim 2, wherein upon authentication of the user by the authentication facility, the scheduling engine is operable to access from the database a user profile corresponding to the authenticated user, and to adapt the scheduling menu based on data included in the user profile.

6. The system as claimed in claim 5, wherein the user profile includes data regarding one or more of the following:
(a) The medical conditions of the user;
(b) The scheduling preferences of the user;
(c) The preferred service provider of the user; and/or
(d) The ongoing treatment plan of the user.

7. The system as claimed in claim 4, wherein the scheduling engine is operable to present to the user one or more tips based on historical data for booking the preferred appointment times of the user.

8. The system claimed in claim 1, wherein the scheduling engine defines a plurality of scheduling rules consisting of:
(a) One or more rules of general application in booking appointments via the computer; and
(b) One or more rules of particular application that reflect particular appointment booking parameters of a particular appointment driven business, such rules of particular application defining a plurality of templates of scheduling rules for different appointment driven businesses.

9. The system claimed in claim 8, wherein the scheduling engine enables the operator of the computer to define one or more custom scheduling rules.

10. The system claimed in claim 1, wherein the computer application includes a call back utility that enables the computer to a make one or more calls to one or more users associated with the computer.

11. The system claimed in claim 10, wherein the computer application defines a waiting list for one or more appointment slots, wherein the scheduling engine enables one or more callers to the computer to provide user input that is operable to enter the one or more callers on the waiting list, the scheduling engine being further operable to administer the waiting list by updating the waiting list based on cancellations or appointment changes affecting the one or more appointment slots, and wherein the call back utility is operable to make a call to the one or more callers in connection with one or more updates to the waiting list.

12. The system as claimed in claim 1, wherein the computer application also includes a prescription renewal utility, wherein the prescription renewal utility is operable to obtain input from the user regarding a prescription that the user wishes to have renewed, and to contact at least one health provider for the user to obtain approval for the renewal of the prescription.

13. The system as claimed in claim 12, wherein the prescription renewal utility is further operable to communicate the prescription renewal to a preferred pharmacist of the user.

14. The system as claimed in claim 1, wherein the computer application also defines on the computer a caller administration utility that is operable to define one or more communication parameters for the handling of calls by the computer, such one or more communication parameters including one or more of the following:
(a) Parameters for invoking a receptionist; and/or
(b) Scheduling of outgoing calls;
(c) Utilization of phone lines connected to the computer.

15. The system as claimed in claim 1, wherein:
(a) The computer consists of a server computer;
(b) The voice messaging utility includes a voice server coupled to one or more voice cards; and
(c) The computer application consists of a server application linked to the server computer;
Wherein the server computer is operable to enable calls to a defined telephone number to be handled by the voice server thereby providing access to callers to the defined telephone number to the resources of the server computer, based on defined parameters.

16. A computer program for automated appointment scheduling, for use in association with a computer, the computer being linked to a voice messaging utility and a database, the computer program comprising computer instructions for defining on the computer:
(a) A scheduling engine that includes a two-way interactive voice response engine, and that enables a user to place a call to the computer and thereby book an appointment by means of a scheduling menu that includes one or more hierarchically defined menu options dynamically defined by the scheduling engine based on user input provided by the user.

17. The computer program claimed in claim 16, wherein the computer program further defines on the computer an authentication utility linked to the scheduling engine, the authentication utility being operable to enable the computer to:
(a) obtain the input of authentication credentials from the user;
(b) compare the authentication credentials to the authentication credentials for the user stored to the database, and based on such authentication credentials authenticate the user to the computer; and
(c) upon authentication of the user to the computer, provide access to resources and/or data linked to the computer that the user is authorized to access.

18. The computer program claimed in claim 16, wherein the scheduling engine enables the scheduling of one or more appointments by users on a fully automated basis.

19. The computer program as claimed in claim 18, wherein the scheduling engine includes a logic engine that is operable to dynamically modify the one or more hierarchically defined menu options so as to reduce the number of irrelevant options presented to the user for the purpose of enabling the user to book the appointment.

20. The computer program as claimed in claim 17, wherein upon authentication of the user by the authentication facility, the scheduling engine is operable to access from the database a user profile corresponding to the authenticated user, and to adapt the scheduling menu based on data included in the user profile.

21. A method of providing automated telephone appointment booking to one or more users comprising the steps of:
(a) Providing a two-way interactive voice communication system that is operable to receive telephone calls from the one or more users;
(b) The one or more users contacting the voice communication system by a dialling a given telephone number;
(c) The voice communication system authenticating each of the one or more users by soliciting authentication data from each of the one or more users, and comparing the authentication data provided with the authentication data associated with the user on a database linked to the voice communication system;
(d) The voice communication system presenting to the one or more users a scheduling menu that includes a plurality of hierarchical menu options defined by an appointment booking process; and
(e) The voice communication system receiving user input from the one or more users, and based on such user input, the voice communication system booking one or more appointments on a fully automated basis.

22. The method claimed in claim 21, comprising the further step of the voice communication system dynamically narrowing the hierarchical menu options, thereby optimizing the efficiency of the booking of the one or more appointments.

23. A method for one or more users to book an, appointment via an automated telephone appointment booking attendant comprising the steps of:
(a) Contacting via telephone a two-way interactive voice communication system;
(b) Providing authentication data to an authentication utility linked to the voice communication system, such authentication utility being operable to compare the authentication data to authentication data for the user stored to a database -linked to the voice communication system; and
(c) Providing user input to one or more scheduling menus defined by a scheduling engine linked to the voice communication system, the scheduling menus defining a plurality of hierarchical menu options corresponding to an appointment booking process, the user thereby booking one or more appointments on a fully automated basis method for one or more users to booking an appointment via an automated telephone appointment booking attendant.
